(19) United States
(12) Patent Application Publication
(10) Pub. No.: US 2006/0085749 A1
(43) Pub. Date: Apr. 20, 2006

(54) System and method for using customizable phrasebooks on multi-function devices

(76) Inventors: Stuart W. Daniel, Lexington, KY (US); Shaun T. Love, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/966,690

(22) Filed: Oct. 15, 2004

(51) Int. Cl. G06F 9/00

(52) U.S. Cl. 715/703

(57) ABSTRACT

The invention provides a device and method for inserting a phrase in a message, wherein the message accompanies a data file representing a document that is sent from a multi-function device. The multi-function device uses a customizable phrasebook including a plurality of phrases that are each associated with an operator-actuated control, and wherein executing a selected operator-actuated control operates to insert the associated phrase in the message.

### FIELD OF THE INVENTION

The present invention relates generally to multi-function devices and more particularly to the use of customizable phrasebooks storable on such devices to add content in the form of characters or phrases to messages that accompany document data files sent from the multi-function device.

### BACKGROUND OF THE INVENTION

In today's increasingly computerized world, both electronic mail (e-mail) and facsimile (fax) are common methods of communication and are increasingly being used to send documents in the form of data files to intended recipients for both business and personal reasons. A multi-function device (MFD), also known as a multi-function printer (MFP) or an All-in-One, typically is configured as either a stand alone or computer peripheral device and is operable to perform several functions such as copying, printing, scanning to e-mail, and scanning to fax.

While various control keys are necessary to operate an MFD, in order to keep costs down, an MFD typically does not include a keyboard. Thus, when scanning a document to be sent via e-mail or fax from such a device, it is often difficult for a user to append explanatory comments or instructions to accompany the scanned document data file. Several multi-function devices are available that use touch screen displays having virtual keyboards. However, these virtual keyboards are often difficult to read and use, which greatly reduces the ability of a user to enter text data.

Further, a user may wish to enter text data that is in a non-alphabetic language such as Chinese. Various computer programs exist that make use of the Romanization of Chinese characters, wherein the sounds of the Chinese characters are transcribed or transliterated into the Roman alphabet. In such programs, the Chinese characters are not input directly, rather, a Roman representation of the character is input using a Roman keyboard and translated into a corresponding Chinese character. One standard Romanization of Chinese characters is Pinyin.

What is needed is the ability to easily enter text including foreign language characters to accompany document data files that are sent from a multi-function device.

### SUMMARY OF THE INVENTION

The invention provides a multi-function device that includes a user interface having a plurality of operator-actuated controls, a scanner for scanning a document and producing a data file, and a controller. The controller stores a customizable phrasebook that includes a plurality of phrases. Each phrase is associated with one of the plurality of controls. The device also includes means responsive to a selected operator-actuated control that operates to insert the associated phrase into a message. The message is sent, via e-mail or fax, for example, along with the data file representing the scanned document.

Further, the invention provides a method for inserting a phrase in a message, wherein the message accompanies a data file representing a document that is sent from a multi-function device. The method includes the steps of defining a customizable phrasebook including a plurality of phrases, and associating each phrase with an operator-actuated control on the multi-function device. The phrasebook is stored on the multi-function device, the execution of a selected operator-actuated control inserts the associated phrase in the message.

Other features and advantages of the invention will become apparent to those skilled in the art upon review of the following detailed description, claims, and drawings.

### BRIEF DESCRIPTION OF THE DRAWINGS

FIG. 1 illustrates a block diagram of a multi-function device;

FIG. 2 illustrates a user interface of a multi-function device; and

FIG. 3 illustrates a screen display for a multi-function printer including a Pinyin phrasebook.

### DETAILED DESCRIPTION OF THE PREFERRED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. The order of limitations specified in any method claims does not imply that the steps or acts set forth therein must be performed in that order, unless an order is explicitly set forth in the specification. In addition, it should be understood that embodiments of the invention include both hardware and electronic components or modules that may be implemented in software. As such, it should be noted that a plurality of hardware and software-based devices, as well as a plurality of different structural components, may be utilized to implement the invention. Furthermore, and as described in subsequent paragraphs, the specific configurations illustrated in the drawings are intended to exemplify embodiments of the invention and that other alternative configurations are possible.

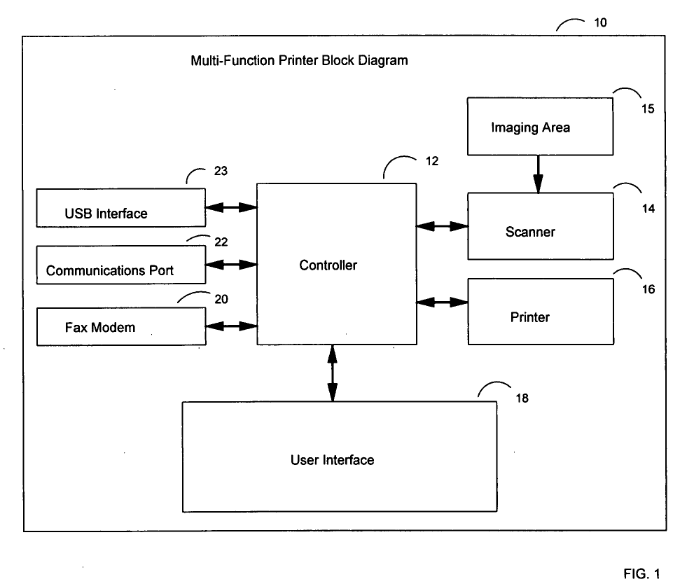

Referring to FIG. 1, a multi-function device 10 is illustrated that provides an exemplary operating environment for one aspect of the present invention. Multi-function device 10 can include a controller 12, scanner 14, imaging area 15, printer 16, user interface 18, communications port 22, fax modem 20 and Universal Serial Bus (USB) port 23. Device 10 can perform various functions including, for example, copying a document, printing, or scanning a document to be sent via e-mail, to be sent via fax, or to be entered into other document workflow applications.

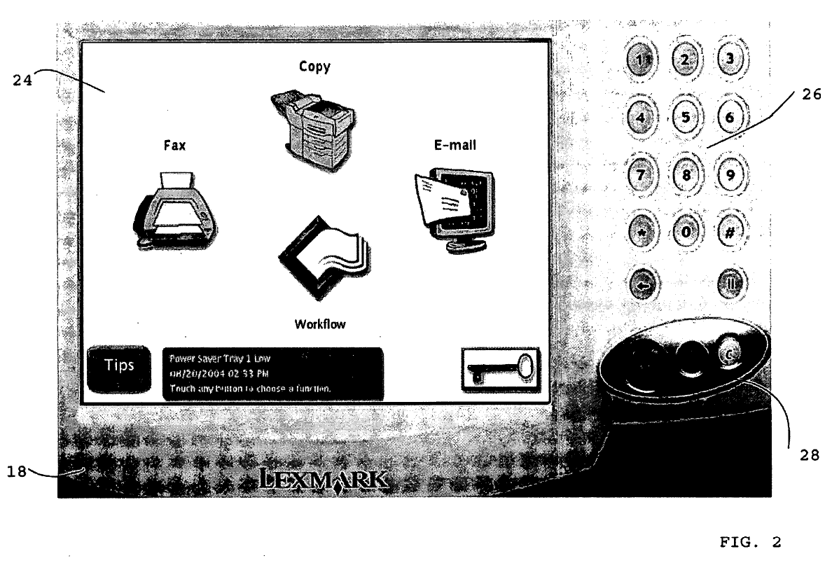

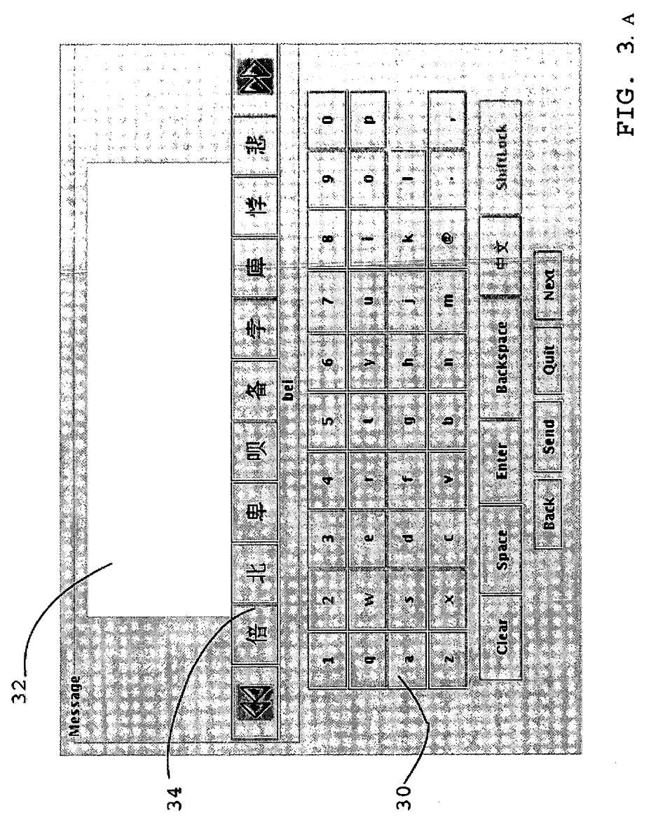

One embodiment of user interface 18 is illustrated in FIG. 2. The user interface 18 can include a display screen 24 that is operable as a touch screen, a numeric keypad 26, and various other control keys 28. The top level display screen, as illustrated in FIG. 2, includes various icons that when touched, access lower level display screens and/or actuate various operations. For example, the top level display screen may include a copy selection, a fax selection, and an e-mail selection. Lower level display screens can also include different selections such as a virtual keyboard having a more or less standard Roman keyboard.

A user can scan to e-mail by placing a document in the imaging area 15 and selecting the e-mail icon on the display screen. Scanner 14 operates to produce a data file having information representative of the document. The user also enters an e-mail address for the intended recipient, and can add message content to the e-mail as described below. The document data file is communicated from the scanner to the controller, the controller then formats the data file, appends message content in response to the execution of operator-actuated controls, and sends the e-mail via port 22, which can be connected to a network, for example.

A user who wants to enter message content to accompany the document data file that is e-mailed may not want to enter large amounts of text via a virtual keyboard on the display screen. Various phrases can be defined in a phrasebook and mapped to operator-actuated controls. The operator-actuated controls may include user prompts such as selections displayed on a display screen or accessed from a pull-down menu, numeric keyboard or other control keys or buttons. When a user makes a selection or presses the control corresponding to a desired prompt, the controller is configured to insert the associated phrase into the message portion of the e-mail to accompany the document data file. The controller also controls the actual sending of e-mail messages.

For example, various messages to accompany a scanned document can be defined and categorized according to differing levels of formality, urgency, or the need for a response. These messages or phrases are then included in a phrasebook. The phrasebook may contain typical phrases for each of several such categories with each phrase being mapped to a single control key or control key sequence, such as on a numeric keyboard or virtual alphabetic keyboard. Example entries and their control key mappings could include the following:

Greetings,1: To whom it may concern:

Greetings,2 Hello!

Message Body, 1: FYI—No response necessary.

Message Body,2: FYI—Any comments?

Message Body,3: Please read and respond at your convenience.

Message Body,4: Urgent! Please read at once and respond immediately.

Closing,Formal,1: Thank you.

Closing,Formal,2: Regards.

Closing,Casual,1: Thanks!

In this phrasebook, the first field is the control key sequence for each phrase, while the second field is the phrase itself. In this implementation, since the phrase and the user prompt are identical, the user prompt may be omitted. In addition, the control key sequence for each phrase consists of one or more categories followed by a numeric key.

By selecting or executing the operator-actuated control corresponding to a desired message phrase, the desired message is inserted in the body portion of an e-mail message, thereby simplifying the insertion of various phrases and perhaps standardizing message content to accompany scanned documents. In the above example, selecting the category labeled “Message Body” and then pressing the numeric key labeled “1” on the user interface would operate to insert the phrase “FYI—No response necessary” in an e-mail message to accompany a document data file.

Similarly, a user of the multi-function device 10 can scan to fax by placing a document in the imaging area 15 and selecting the fax icon on the display screen. Scanner 14 operates to produce a data file having information representative of the document. The user would enter the recipient's fax number (or select it from a previously stored number via a shortcut key or address book). The user can also add message content to the fax as described below. The document data file is communicated to the controller, which formats the data file, appends the desired message content, and sends the fax via fax modem 20.

Using the phrasebook described above, if a user selects the category “Message Body” and then presses the numeric key labeled “3”, the phrase “Please read and respond at your convenience” would then be added to a message accompanying the document data file. In the case of a fax, a separate “cover page” would be created including the desired message content, which would be printed as a cover page separate from the replicated document at the destination.

A user may also desire to enter his document into a document workflow system. This can be done by placing a document in the imaging area 15 and selecting the appropriate workflow icon on the display screen 24. Scanner 14 operates to produce a data file having information representative of the document. It may be desirable to provide descriptive comments that will accompany the document or even help direct its movement through the document workflow system. For example, documents being sent to the personnel department may require varying levels of confidentiality. A phrasebook may contain a message for each of the possible levels of required confidentiality. Example entries and their control key mappings could include the following:

Classification,1: Internal use only

Classification,2: Confidential

Classification,3: Confidential Restricted

Using this phrasebook, if a user presses the numeric key labeled “3”, the phrase “Confidential Restricted” would then be added to a message accompanying the document data file as it proceeds through the document workflow system. This message could ensure that the document is routed through the workflow process only in a manner that provides greatest security.

The phrasebook itself and mappings to operator-actuated controls can take many different forms. In one embodiment, a pull down menu on the display screen may contain various headings including, for example, Salutations, Message Body phrases, and Closings. Each heading would correspond to a set of phrases that can be inserted to compose a message. Specific phrases are selected by first selecting from the various headings and then selecting a desired phrase from the user prompts displayed under the selected heading. Various levels of embedded selections are also envisioned.

The phrasebook may be provided as a lookup table in the controller 12. The phrasebook may also be provided in any of several other data structures such as a linked list, tree or file structure. The phrasebook may also reside outside of controller 12 and be accessed via communications port 22 or USB port 23. The size and content of the phrasebook is arbitrary and in a preferred embodiment, new phrases can be added based on the users' needs. In one embodiment, the phrases are stored using standardized code sets such as Unicode UTF-8, UTF-16 or UTF-32. Other standard or non-standard data structures can also be employed in other embodiments.

In the phrasebook described above, the user prompts are in English and are identical to the associated phrases. Consequently, user prompts are not required in the phrasebook above. In one alternative embodiment, the phrasebooks can also be used to translate one language into another. This would allow a user to construct a useful message consisting of one or more phrases in a language the user may not be familiar with, and the message content retrieved from the phrasebook could be in a different language. In one embodiment, each output phrase in the phrasebook would have an associated user prompt:

Classification,1: “Document Confidentiel”, “Confidential Document”

Closings,1: “Merci”, “Thank you”

Using this phrasebook, a user would first choose the “Closings” category on the user interface. The user prompt “Thank you” would then appear on the interface. By activating this selection, the phrase “Merci” would be added to the message.

Different phrasebooks can be downloaded via communications port 22 or USB port 23, specific to the type of business of the user, for example, or the specific needs of the user. In another embodiment, the controller 12 may access phrasebooks stored on a removable storage device (such as a floppy disk drive or memory card reader) attached to or integrated into multi-function device 10.

A phrasebook can also be configured to provide a translation of a string of Roman characters into a corresponding Chinese character, word or phrase. There exist many hundreds of mappings that have been devised to facilitate the use of a Roman keyboard to enter Chinese on a computer workstation, for example. Such methods can be set up as a phrasebook on a multi-function device. As mentioned, Pinyin is a phonetic spelling of a Chinese character using Roman symbols. Because each Chinese character is one syllable, each can be spelled phonetically as one of approximately a few hundred pronunciations. The fact that there are thousands of Chinese characters means that there are several different Chinese character choices for each possible pronunciation.

A portion of a Pinyin phrasebook, or mapping of Roman characters to Unicode Chinese characters follows. The Chinese characters are specified as 16-bit hexadecimal codepoints, and the user prompts are identical to the inserted phrases:
r,a,o: 0×C8C5
r,a,o: 0×E6AC
r,a,o: 0×C8C6
r,e: 0×C8C7
r,e: 0×C8F4
r,e: 0×DFF6
r,e: 0×C8C8
r,e,n: 0×C8C9
r,e,n: 0×C8CA
r,e,n: 0×C8CB
r,e,n: 0×C8CE

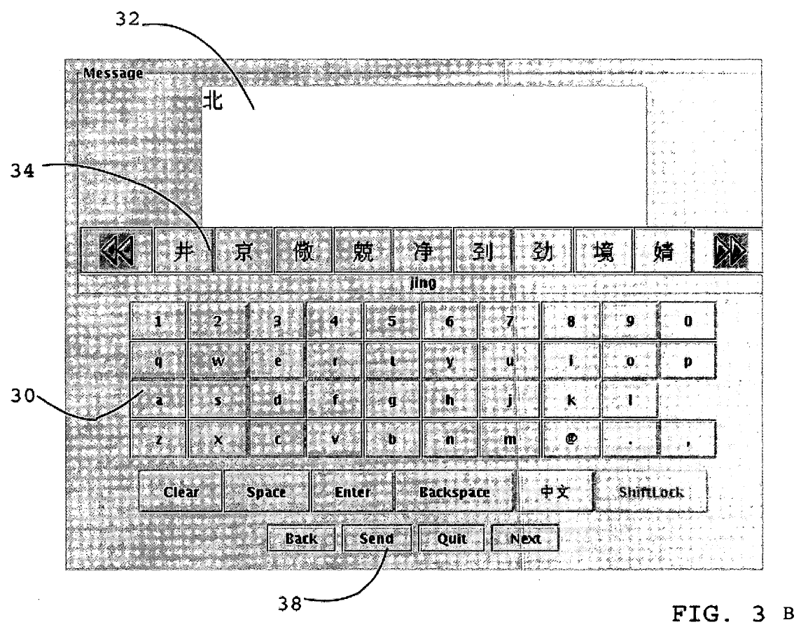

FIG. 3 illustrates a user interface for adding Chinese characters using a virtual keyboard that is more or less a standard Roman keyboard. In FIG. 3A, the user has entered “Bei” using keyboard 30. Several output options are displayed in selection or option area 34. In FIG. 3B, the option selected from option area 34 has been added to the message in message area 32. The user next entered “jing” using keyboard 30 and corresponding Chinese characters are displayed in option area 34. When the complete message has been composed, these Chinese characters and words can then be inserted as message content to accompany a document data file for e-mail or fax by selecting the transmit or Send key 38.

Another common method for inputting Chinese characters on a work station is known as “Wubi”. This method decomposes the Chinese character into constituent strokes and maps different stroke types to a Roman keyboard. The resulting sequence of Roman characters, each of which corresponds to a stroke within the Chinese character, corresponds to a unique Chinese character. This method can also be implemented using phrasebooks on a multi-function device. Here the “phrase” that is output is really a Chinese character. Each keystroke in the sequence that corresponds to the spelling of Chinese character displays a set of subcategories from which to choose possible next keystrokes. When the spelling is complete, the user selects the desired character from a listing containing all the Chinese characters with that spelling.

Of course, other embodiments of the invention can be used to generate other non-Roman characters such as, for example, Arabic, Greek, and Russian, and non-textual characters such as glyphs or graphemes or other abstract forms. Various features and advantages of the invention are set forth in the following claims.

What is claimed is:

1. A method for inserting a phrase in a message, wherein the message accompanies a data file representing a document that is sent from a multi-function device, the method comprising the steps of:
defining a phrasebook including a plurality of phrases,
associating each phrase with an operator-actuated control on the multi-function device, and
executing a selected operator-actuated control to insert the associated phrase in the message.

2. The method of claim 1, further including the steps of providing an e-mail address to define a recipient of the message, and sending the message via e-mail.

3. The method of claim 1, further including the steps of providing a fax number to define a recipient of the message, and sending the message via fax.

4. The method of claim 1, wherein each phrase is associated with an on-screen display control.

5. The method of claim 1, wherein each phrase is associated with an input key on a numeric keyboard.

6. The method of claim 1, further including the step of storing the phrasebook on the multi-function device.

7. The method of claim 1, wherein the phrasebook is accessed via one of a network and USB connection.

8. The method of claims 1, wherein the phrasebook is accessed from a removable storage device.

9. The method of claim 1, wherein the phrases in the phrasebook relate to a requested response by an intended recipient.

10. The method of claim 1, wherein each operator-actuated control is selected from a touch screen display.

11. The method of claim 1, wherein each operator-actuated control is selected from a numeric keypad.

12. The method of claim 1, further including the step of entering the data file into a document workflow system.

13. The method of claim 1, wherein the phrasebook is customizable.

14. The method of claim 1 wherein the associated phrase is associated with a user prompt.

15. The method of claim 14 wherein the associated phrase is in a first language and the associated user prompt is in a second language.

16. The method of claim 15 wherein the associated phrase is a translation of said associated user prompt.

17. A method for inserting non-Roman characters to form words in a message, wherein the message accompanies a data file representing a document that is sent from a multi-function device, the method comprising the steps of:
defining a phrasebook including a plurality of non-Roman characters in the multi-function device,
associating each character with an input key operation sequence with the input keys corresponding to a standard Roman character keyboard, and
executing a selected input key operation sequence to insert an associated character in the message.

18. The method of claim 17, further including the steps of providing an e-mail address to define a recipient of the message, and sending the message via e-mail.

19. The method of claim 17, further including the steps of providing a fax number to define a recipient of the message, and sending the message via fax.

20. The method of claim 17, wherein each character is associated with an input key operation sequence on a virtual keyboard on a display screen.

21. The method of claim 17, wherein each character is selected from the group including Chinese characters and Japanese characters.

22. The method of claim 17, wherein the phrasebook is downloaded via a network connection.

23. The method of claim 17, further including the step of customizing the phrasebook.

24. A multi-function device, comprising:
a user interface including a plurality of operator-actuated controls,
a scanner for scanning a document and producing a data file,
a controller for accessing a phrasebook including a plurality of phrases, each phrase associated with one of the plurality of controls,
means responsive to a selected operator-actuated control for inserting the associated phrase into a message, and
means for sending the message along with the data file representing the scanned document.

25. The multi-function device according to claim 24, wherein the message is sent as an e-mail.

26. The multi-function device according to claim 24, wherein the message is sent as a fax.

27. The multi-function device according to claim 24, further including means for storing a phrasebook in the controller.

28. The multi-function device according to claim 24, wherein the phrasebook is accessed from one of a network and a USB connection.

29. The multi-function device according to claim 24, wherein the phrasebook is accessed from a removable storage device.

30. The multi-function device according to claim 24, wherein the user interface does not include a real keyboard.

31. The multi-function device according to claim 24, wherein the phrasebook is customizable.

32. A method for inserting an output phrase in a message, wherein the message accompanies a data file representing a document that is sent from a multi-function device, the method comprising the steps of:
associating each of a plurality of output phrases with a corresponding input message on the multi-function device,
inputting a selected input message on the multi-function device to thereby access a corresponding output phrase and insert said output phrase in the sent message, wherein the output phrase is greater than the input message.

33. The method of claim 32, wherein the number of characters in the output phrase is greater than the number of characters in the input message.

34. The method of claim 32, wherein the output phrase comprises multi-byte characters and the corresponding input message comprises single byte characters.

35. The method of claim 32, wherein the input message is in a first language, and the corresponding output phrase is in a second language.

36. The method of claim 32, wherein the output phrase is a translation of the corresponding input message.
